(19) United States
(12) Patent Application Publication
(10) Pub. No.: US 2023/0259412 A1
(43) Pub. Date: Aug. 17, 2023

(54) HARDWARE-BASED ACCELERATORS IN CLOUD NATIVE APPLICATIONS WRITTEN IN HIGH LEVEL PROGRAMMING LANGUAGES

(71) Applicant: Intel Corporation, Santa Clara, CA (US)

(72) Inventors: Haokun Xing, Shanghai (CN); Miaomiao Liu, Shanghai (CN); Hualong Feng, Shanghai (CN); Ziye Yang, Shanghai (CN); Junyuan Wang, Shanghai (CN)

(21) Appl. No.: 18/136,972

(22) Filed: Apr. 20, 2023

(30) Foreign Application Priority Data
Nov. 4, 2022 (WO) PCT/CN2022/129855

(51) Int. Cl. G06F 9/54

(52) U.S. Cl. CPC G06F 9/541; G06F 9/547

(57) ABSTRACT

Various methods, systems, and use cases for providing a wrapper application programming interface (API). The wrapper API can invoke hardware accelerator libraries based on function calls from cloud native applications.

This application claims the benefit of priority to International Application No. PCT/CN2022/129855, filed Nov. 4, 2022, which is incorporated herein by reference in its entirety.

### BACKGROUND

Cloud Native (CN) programming is very rapidly emerging programming and services deployment paradigm that allows seamless scalability across functions, highly distributed deployments, demand-based scaling up/down, deployment agility, using a combination of cloud computing and edge computing concepts. Many CN applications are written in certain computing languages that can be difficult or complex to integrate with hardware-based accelerators written in other computing languages.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates an overview of an edge cloud configuration for edge computing.

FIG. 2 illustrates operational layers among endpoints, an edge cloud, and cloud computing environments.

FIG. 3 illustrates an example approach for networking and services in an edge computing system.

FIG. 4 illustrates deployment of a virtual edge configuration in an edge computing system operated among multiple edge nodes and multiple tenants.

FIG. 5 illustrates a lightweight wrapper application programming interface for integrating hardware-based accelerators according to some embodiments.

FIG. 6 illustrates a usage example in a container running time environment according to some embodiments.

FIG. 7 illustrates a method to enable hardware-based accelerators in cloud native applications written in high level programming languages according to some embodiments.

FIG. 8A provides an overview of example components for compute deployed at a compute node in an edge computing system.

FIG. 8B provides a further overview of example components within a computing device in an edge computing system.

### DETAILED DESCRIPTION

### Background and Example Systems

The following embodiments generally relate to Cloud Native (CN) computing. CN is rapidly emerging as a programming and services deployment paradigm that allows seamless scalability across functions, highly distributed deployments, demand-based scaling up/down, and deployment agility, using a combination of cloud computing and edge computing concepts. Many CN applications are written using Golang and Rust. Golang (also known in some contexts as GO) is a programming language for developing scalable servers and large software systems. Rust is an open-source systems programming language that emphasizes performance, type safety and useability (e.g., community support is relatively high for Rust development). Currently, Rust is emerging as a language of choice for confidential containers, service mesh, distributed databases, observability/telemetry, language runtime, and other applications and use cases.

Software can have some needs met by accelerators in areas such as compression/decompression, encryption/decryption, copying and moving data, data integrity operations, and network operations. While Rust and other CN application languages are becoming more popular, it can be complex and non-trivial to integrate hardware-based accelerators written in high-level programming languages with CN applications. Development teams that create or design hardware accelerators will usually work with software development teams to develop related software components in firmware, kernel, or other languages. However, the languages typically used are C/C++, and there is limited support for developing hardware accelerators for CN applications written in, e.g., Golang, Rust, or Java. Some development has been done using application programming interfaces (APIs) for certain hardware accelerators, but these still do not have high-level language support, and furthermore such APIs have only been developed for a subset of accelerators (e.g., graphics processing units (GPUs)) and may only relate to subsets of work performed by these accelerators (e.g., offloading work). The lack of high-level language support can limit or restrict adoption of hardware accelerators.

Some example hardware accelerators that should be interoperable or usable with CN applications written in Golang and Rust can include Intel® QuickAssist Technology (QAT), Intel® In-Memory Analytics Accelerator (IAA) or Intel® Data Streaming Accelerator (DSA). Other accelerators can include Cryptographic CoProcessor (CCP) or other accelerators available from Advanced Micro Devices, Inc. (AMD®) of Sunnyvale, Calif. Still further accelerators can include an ARM®-based accelerators available ARM Holdings, Ltd., or a customer thereof, or their licensees or adopters, such as Security Algorithm Accelerators and CryptoCell-300 Family accelerators. Further accelerators can include AI Cloud Accelerator (QAIC) available from Qualcomm® Technologies, Inc. CN applications can be provided by Cloud providers (CSPs) such as Amazon Web Services (AWS), Google Cloud Platform (GCP), VMWare cloud platform, Alibaba Cloud, Tencent Cloud, Huawei Cloud, and China Telecom CSP etc.

Example embodiments can narrow the gaps between Rust/Golang, etc. with languages used to develop hardware accelerators. Existing solutions for narrowing this gap can include solutions to leverage accelerators. These solutions can include a client-server solution that makes use of a (G)PRC framework, in which applications (e.g., on the client) written in high level programming languages (such as JAVA, Golang or Rust) can use remote procedure calls (RPC) to invoke the offloading device integrated in the RPC server side. The server application can be written in, e.g., the C language. The server will do the actual work corresponding the request and send a result to the client. Using this methodology, applications do not directly integrate accelerated devices but communicate with the service over one interface. Furthermore, the client (e.g., the Rust client) can use remote resources thereby expanding available resources. However, to use this solution, to make use of the accelerators, an additional communication channel is needed (e.g., http(s)/TCP/RDMA/Unix domain socket). If data is also exchanged by the RPC channel, then acceleration benefits may be lost or reduced because of the communication overhead involved to implement RPC. Finally, interface design may be difficult between the server and client. Trusted environments can cause further issues.

Other approaches include C->GO or Rust-->C approaches in which high level programming languages can directly use functions written in C. This in turn can make it simpler or less complex to use C libraries to invoke those hardware accelerators. However, currently there are no readily available, stable wrapper APIs provided. Further, particularly in the case of CN applications in Rust, additional work would be needed to enable hardware-based accelerators. For example, in Rust there are currently only a limited number of wrapper libraries to leverage io_uring in the C language (e.g., tokio-uring).

Still further, other approaches can use advanced languages such as Python developed separate libraries that can access hardware resources (e.g., memory mapped I/O (MMI)) and perform direct memory access (DMA) directly. An example Python library can include pynq.lib.dma. However, Python-based solutions rely on the implementation mode of a device driver, and the device drive should expose all interfaces via the MMIO interface. This can lead to the need for intensive device driver rework efforts, and in this mode, it can be difficult to control the access privileges from the user space applications and potential security vulnerabilities may be introduced. Further, the applications will still need to deal with different device drivers.

Example embodiments address these and other concerns by providing methods to enable hardware accelerators (e.g., any of the example accelerators described above, and any other accelerators in particular cryptographic accelerators although embodiments are not limited thereto) in high level programming languages (e.g., Rust, GO). Embodiments herein are described with particular reference to Rust although embodiments are not limited to Rust and can be used with any CN languages or languages/syntaxes/technologies popular in CN development. Example embodiments provide a wrapper library to leverage some accelerators (e.g., QAT/DSA, or accelerators described above, although embodiments are not limited thereto) for Rust.

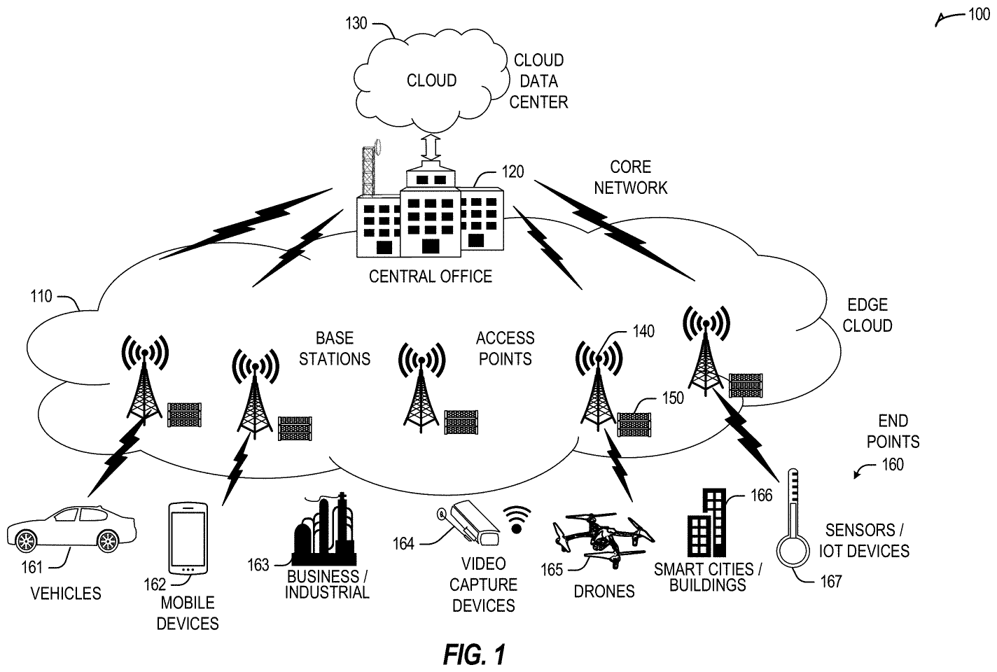

Example embodiments can be implemented in containers, and any container or container-running component can be adapted using example embodiments to provide capabilities described herein. Methods, devices, software/firmware, etc. can provide a performance benefit for cloud native applications written in high level programming languages (e.g., by Golang/Rust) on platforms described herein. Cloud service providers can efficiently utilize the accelerators and accelerator platforms in different software components in the stack. Gaps described earlier herein can be reduced or eliminated, such that accelerators can support cloud native applications written in high level programming languages. Example embodiments can be implemented in any of the platforms or systems described below with reference to FIG. 1-4.

### Example Systems

FIG. 1 is a block diagram 100 showing an overview of a configuration for edge computing, which includes a layer of processing referred to in many of the following examples as an “edge cloud”. As shown, the edge cloud 110 is co-located at an edge location, such as an access point or base station 140, a local processing hub 150, or a central office 120, and thus may include multiple entities, devices, and equipment instances. The edge cloud 110 is located much closer to the endpoint (consumer and producer) data sources 160 (e.g., autonomous vehicles 161, user equipment 162, business and industrial equipment 163, video capture devices 164, drones 165, smart cities and building devices 166, sensors and IoT devices 167, etc.) than the cloud data center 130. Compute, memory, and storage resources which are offered at the edges in the edge cloud 110 are critical to providing ultra-low latency response times for services and functions used by the endpoint data sources 160 as well as reduce network backhaul traffic from the edge cloud 110 toward cloud data center 130 thus improving energy consumption and overall network usages among other benefits.

Compute, memory, and storage are scarce resources, and generally decrease depending on the edge location (e.g., fewer processing resources being available at consumer endpoint devices, than at a base station, than at a central office). However, the closer that the edge location is to the endpoint (e.g., user equipment (UE)), the more that space and power is often constrained. Thus, edge computing attempts to reduce the number of resources needed for network services, through the distribution of more resources which are located closer both geographically and in network access time. In this manner, edge computing attempts to bring the compute resources to the workload data where appropriate, or bring the workload data to the compute resources.

The following describes aspects of an edge cloud architecture that covers multiple potential deployments and addresses restrictions that some network operators or service providers may have in their own infrastructures. These include, variation of configurations based on the edge location (because edges at a base station level, for instance, may have more constrained performance and capabilities in a multi-tenant scenario); configurations based on the type of compute, memory, storage, fabric, acceleration, or like resources available to edge locations, tiers of locations, or groups of locations; the service, security, and management and orchestration capabilities; and related objectives to achieve usability and performance of end services. These deployments may accomplish processing in network layers that may be considered as “near edge,” “close edge,” “local edge,” “middle edge,” or “far edge” layers, depending on latency, distance, and timing characteristics.

Edge computing is a developing paradigm where computing is performed at or closer to the “edge” of a network, typically through the use of a compute platform (e.g., x86 or ARM compute hardware architecture) implemented at base stations, gateways, network routers, or other devices which are much closer to endpoint devices producing and consuming the data (e.g., at a “local edge”, “close edge”, or “near edge”). For example, edge gateway servers may be equipped with pools of memory and storage resources to perform computation in real-time for low latency use-cases (e.g., autonomous driving or video surveillance) for connected client devices. Or as an example, base stations may be augmented with compute and acceleration resources to directly process service workloads for connected user equipment, without further communicating data via backhaul networks. Or as another example, central office network management hardware may be replaced with standardized compute hardware that performs virtualized network functions and offers compute resources for the execution of services and consumer functions for connected devices. Within edge computing networks, there may be scenarios in services which the compute resource will be “moved” to the data, as well as scenarios in which the data will be “moved” to the compute resource. Or as an example, base station compute, acceleration and network resources can provide services to scale to workload demands on an as needed basis by activating dormant capacity (subscription, capacity on demand) in order to manage corner cases, emergencies or to provide longevity for deployed resources over a significantly longer implemented lifecycle.

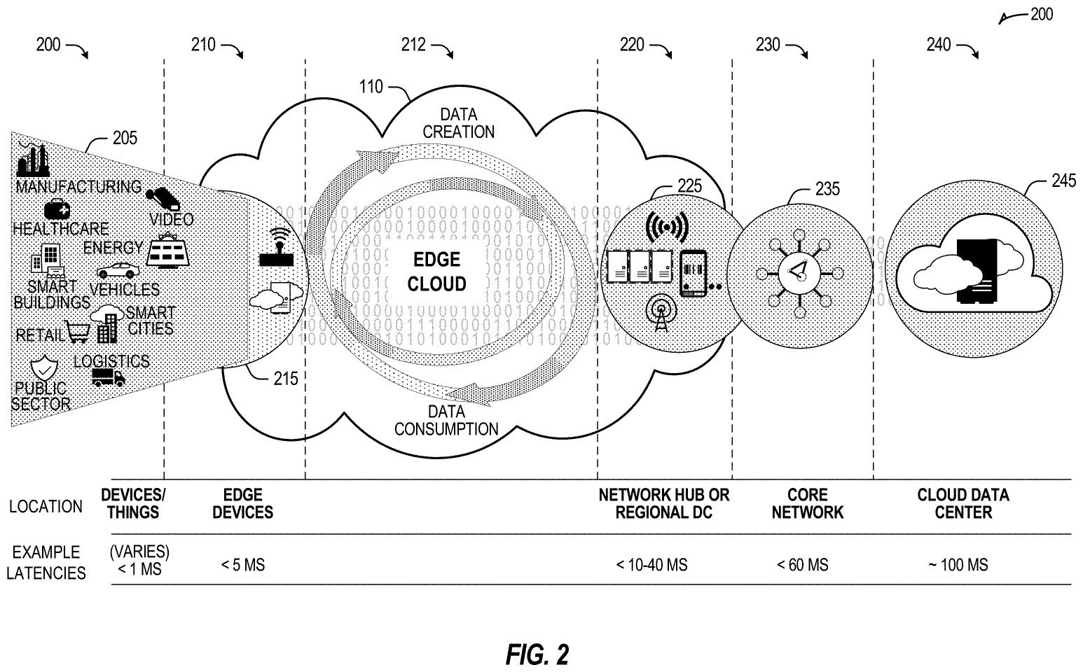

FIG. 2 illustrates operational layers among endpoints, an edge cloud, and cloud computing environments. Specifically, FIG. 2 depicts examples of computational use cases 205, utilizing the edge cloud 110 among multiple illustrative layers of network computing. The layers begin at an endpoint (devices and things) layer 200, which accesses the edge cloud 110 to conduct data creation, analysis, and data consumption activities. The edge cloud 110 may span multiple network layers, such as an edge devices layer 210 having gateways, on-premises servers, or network equipment (nodes 215) located in physically proximate edge systems; a network access layer 220, encompassing base stations, radio processing units, network hubs, regional data centers (DC), or local network equipment (equipment 225); and any equipment, devices, or nodes located therebetween (in layer 212, not illustrated in detail). The network communications within the edge cloud 110 and among the various layers may occur via any number of wired or wireless mediums, including via connectivity architectures and technologies not depicted.

Examples of latency, resulting from network communication distance and processing time constraints, may range from less than a millisecond (ms) when among the endpoint layer 200, under 5 ms at the edge devices layer 210 (e.g., a “near edge” or “close edge” layer), to even between 10 to 40 ms when communicating with nodes at the network access layer 220 (e.g., a “middle edge” layer). Beyond the edge cloud 110 are core network 230 and cloud data center 240 layers, each with increasing latency (e.g., between 50-60 ms at the core network 230, to 100 or more ms at the cloud data center layer, both of which may be considered a “far edge” layer). As a result, operations at a core network data center 235 or a cloud data center 245, with latencies of at least 50 to 100 ms or more, will not be able to accomplish many time-critical functions of the use cases 205. Each of these latency values are provided for purposes of illustration and contrast; it will be understood that the use of other access network mediums and technologies may further reduce the latencies.

The various use cases 205 may access resources under usage pressure from incoming streams, due to multiple services utilizing the edge cloud. To achieve results with low latency, the services executed within the edge cloud 110 balance varying requirements in terms of: (a) Priority (throughput or latency) and Quality of Service (QoS) (e.g., traffic for an autonomous car may have higher priority than a temperature sensor in terms of response time requirement; or, a performance sensitivity/bottleneck may exist at a compute/accelerator, memory, storage, or network resource, depending on the application); (b) Reliability and Resiliency (e.g., some input streams need to be acted upon and the traffic routed with mission-critical reliability, where as some other input streams may be tolerate an occasional failure, depending on the application); and (c) Physical constraints (e.g., power, cooling and form-factor).

The end-to-end service view for these use cases involves the concept of a service-flow and is associated with a transaction. The transaction details the overall service requirement for the entity consuming the service, as well as the associated services for the resources, workloads, workflows, and business functional and business level requirements. The services executed with the “terms” described may be managed at each layer in a way to assure real time, and runtime contractual compliance for the transaction during the lifecycle of the service. When a component in the transaction is missing its agreed to SLA, the system as a whole (components in the transaction) may provide the ability to (1) understand the impact of the SLA violation, and (2) augment other components in the system to resume overall transaction SLA, and (3) implement steps to remediate.

Thus, with these variations and service features in mind, edge computing within the edge cloud 110 may provide the ability to serve and respond to multiple applications of the use cases 205 (e.g., object tracking, video surveillance, connected cars, etc.) in real-time or near real-time, and meet ultra-low latency requirements for these multiple applications. These advantages enable a whole new class of applications (Virtual Network Functions (VNFs), Function as a Service (FaaS), Edge as a Service (EaaS), standard processes, etc.), which cannot leverage conventional cloud computing due to latency or other limitations.

However, with the advantages of edge computing comes the following caveats. The devices located at the edge are often resource constrained and therefore there is pressure on usage of edge resources. Typically, this is addressed through the pooling of memory and storage resources for use by multiple users (tenants) and devices. The edge may be power and cooling constrained and therefore the power usage needs to be accounted for by the applications that are consuming the most power. There may be inherent power-performance tradeoffs in these pooled memory resources, as many of them are likely to use emerging memory technologies, where more power requires greater memory bandwidth. Likewise, improved security of hardware and root of trust trusted functions are also required because edge locations may be unmanned and may even need permissioned access (e.g., when housed in a third-party location). Such issues are magnified in the edge cloud 110 in a multi-tenant, multi-owner, or multi-access setting, where services and applications are requested by many users, especially as network usage dynamically fluctuates and the composition of the multiple stakeholders, use cases, and services changes.

At a more generic level, an edge computing system may be described to encompass any number of deployments at the previously discussed layers operating in the edge cloud 110 (network layers 200-240), which provide coordination from client and distributed computing devices. One or more edge gateway nodes, one or more edge aggregation nodes, and one or more core data centers may be distributed across layers of the network to provide an implementation of the edge computing system by or on behalf of a telecommunication service provider (“telco”, or “TSP”), internet-of-things service provider, cloud service provider (CSP), enterprise entity, or any other number of entities. Various implementations and configurations of the edge computing system may be provided dynamically, such as when orchestrated to meet service objectives.

Consistent with the examples provided herein, a client compute node may be embodied as any type of endpoint component, device, appliance, or other thing capable of communicating as a producer or consumer of data. Further, the label “node” or “device” as used in the edge computing system does not necessarily mean that such node or device operates in a client or agent/minion/follower role; rather, any of the nodes or devices in the edge computing system refer to individual entities, nodes, or subsystems which include discrete or connected hardware or software configurations to facilitate or use the edge cloud 110.

As such, the edge cloud 110 is formed from network components and functional features operated by and within edge gateway nodes, edge aggregation nodes, or other edge compute nodes among network layers 210-230. The edge cloud 110 thus may be embodied as any type of network that provides edge computing and/or storage resources which are proximately located to radio access network (RAN) capable endpoint devices (e.g., mobile computing devices, IoT devices, smart devices, etc.), which are discussed herein. In other words, the edge cloud 110 may be envisioned as an “edge” which connects the endpoint devices and traditional network access points that serve as an ingress point into service provider core networks, including mobile carrier networks (e.g., Global System for Mobile Communications (GSM) networks, Long-Term Evolution (LTE) networks, 5G/6G networks, etc.), while also providing storage and/or compute capabilities. Other types and forms of network access (e.g., Wi-Fi, long-range wireless, wired networks including optical networks) may also be utilized in place of or in combination with such 3GPP carrier networks.

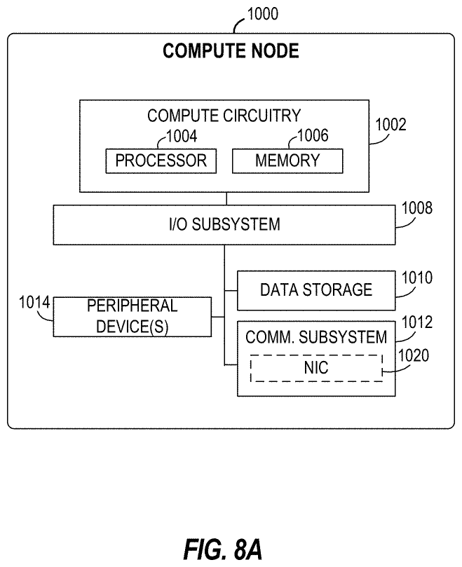

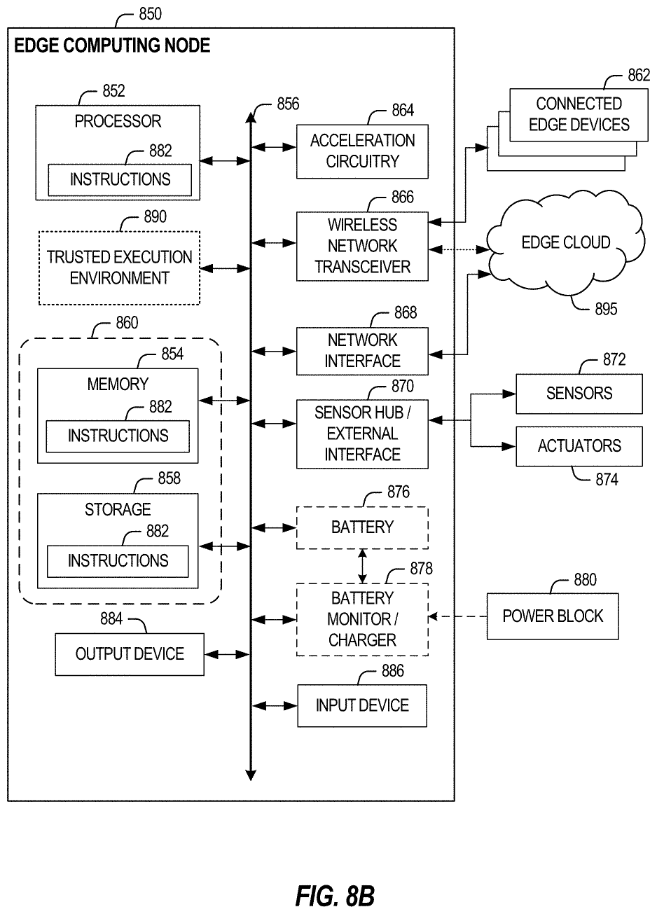

The network components of the edge cloud 110 may be servers, multi-tenant servers, appliance computing devices, and/or any other type of computing devices. For example, the edge cloud 110 may be an appliance computing device that is a self-contained processing system including a housing, case, or shell. In some cases, edge devices are devices presented in the network for a specific purpose (e.g., a traffic light), but that have processing or other capacities that may be harnessed for other purposes. Such edge devices may be independent from other networked devices and provided with a housing having a form factor suitable for its primary purpose; yet be available for other compute tasks that do not interfere with its primary task. Edge devices include Internet of Things devices. The appliance computing device may include hardware and software components to manage local issues such as device temperature, vibration, resource utilization, updates, power issues, physical and network security, etc. Example hardware for implementing an appliance computing device is described in conjunction with FIG. 8B. The edge cloud 110 may also include one or more servers and/or one or more multi-tenant servers. Such a server may implement a virtual computing environment such as a hypervisor for deploying virtual machines, an operating system that implements containers, etc. Such virtual computing environments provide an execution environment in which one or more applications may execute while being isolated from one or more other applications.

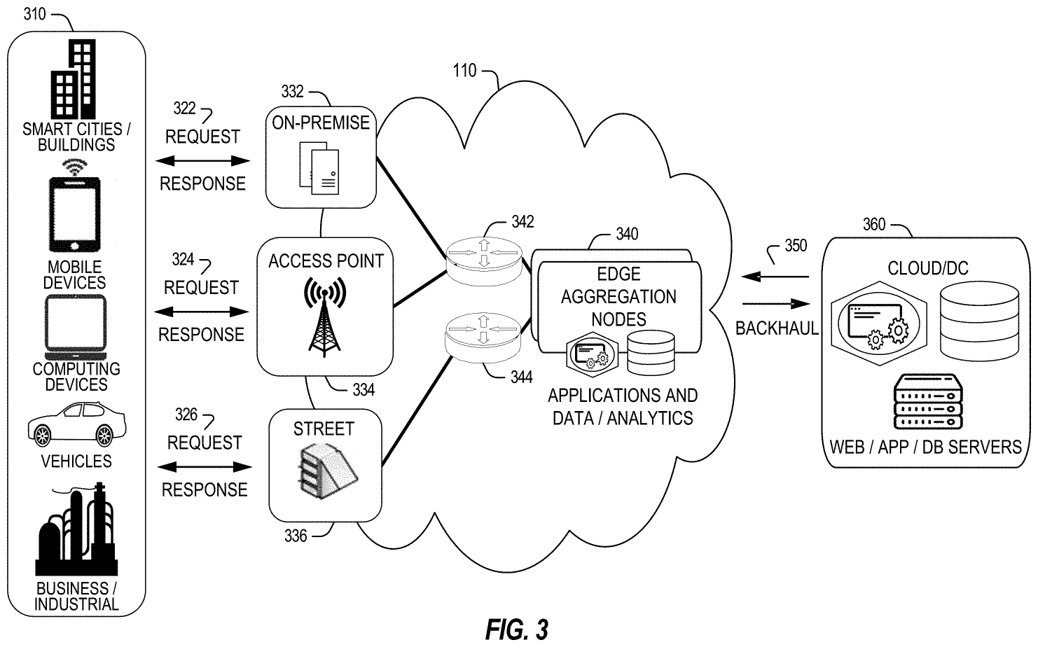

In FIG. 3, various client endpoints 310 (in the form of mobile devices, computers, autonomous vehicles, business computing equipment, industrial processing equipment) exchange requests and responses that are specific to the type of endpoint network aggregation. For instance, client endpoints 310 may obtain network access via a wired broadband network, by exchanging requests and responses 322 through an on-premises network system 332. Some client endpoints 310, such as mobile computing devices, may obtain network access via a wireless broadband network, by exchanging requests and responses 324 through an access point (e.g., cellular network tower) 334. Some client endpoints 310, such as autonomous vehicles may obtain network access for requests and responses 326 via a wireless vehicular network through a street-located network system 336. However, regardless of the type of network access, the TSP may deploy aggregation points 342, 344 within the edge cloud 110 to aggregate traffic and requests. Thus, within the edge cloud 110, the TSP may deploy various compute and storage resources, such as at edge aggregation nodes 340, to provide requested content. The edge aggregation nodes 340 and other systems of the edge cloud 110 are connected to a cloud or data center 360, which uses a backhaul network 350 to fulfill higher-latency requests from a cloud/data center for websites, applications, database servers, etc. Additional or consolidated instances of the edge aggregation nodes 340 and the aggregation points 342, 344, including those deployed on a single server framework, may also be present within the edge cloud 110 or other areas of the TSP infrastructure.

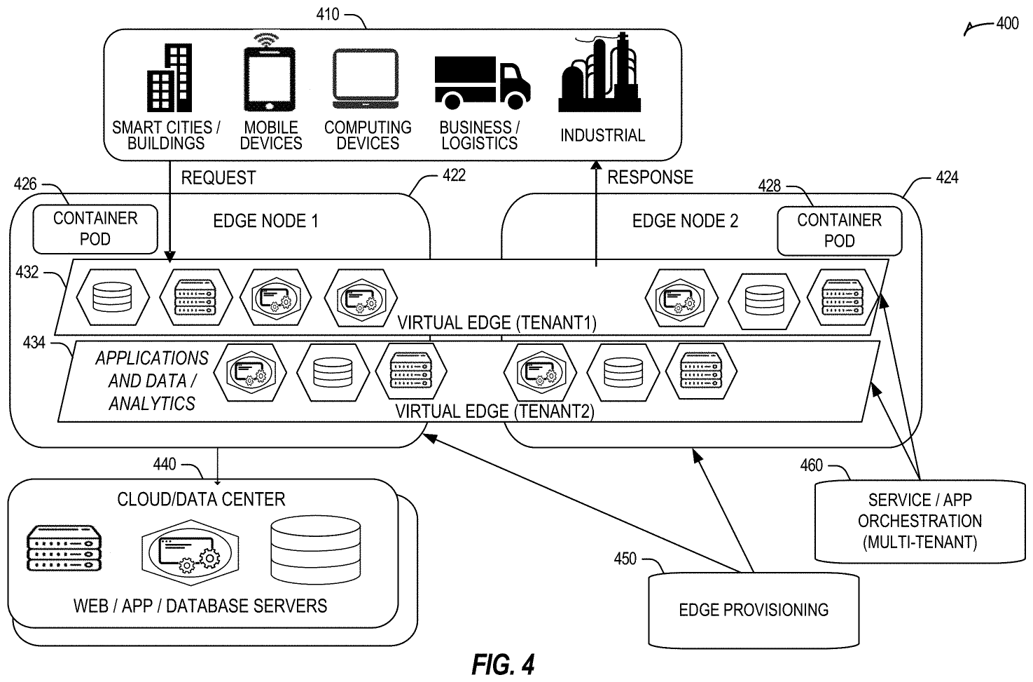

FIG. 4 illustrates deployment and orchestration for virtual edge configurations across an edge computing system operated among multiple edge nodes and multiple tenants. Specifically, FIG. 4 depicts coordination of a first edge node 422 and a second edge node 424 in an edge computing system 400, to fulfill requests and responses for various client endpoints 410 (e.g., smart cities/building systems, mobile devices, computing devices, business/logistics systems, industrial systems, etc.), which access various virtual edge instances. Here, the virtual edge instances 432, 434 provide edge compute capabilities and processing in an edge cloud, with access to a cloud/data center 440 for higher-latency requests for websites, applications, database servers, etc. However, the edge cloud enables coordination of processing among multiple edge nodes for multiple tenants or entities.

In the example of FIG. 4, these virtual edge instances include: a first virtual edge 432, offered to a first tenant (Tenant 1), which offers a first combination of edge storage, computing, and services; and a second virtual edge 434, offering a second combination of edge storage, computing, and services. The virtual edge instances 432, 434 are distributed among the edge nodes 422, 424, and may include scenarios in which a request and response are fulfilled from the same or different edge nodes. The configuration of the edge nodes 422, 424 to operate in a distributed yet coordinated fashion occurs based on edge provisioning functions 450. The functionality of the edge nodes 422, 424 to provide coordinated operation for applications and services, among multiple tenants, occurs based on orchestration functions 460.

It should be understood that some of the various client endpoints in 410 are multi-tenant devices where Tenant 1 may function within a tenant1 ‘slice’ while a Tenant 2 may function within a tenant2 slice (and, in further examples, additional or sub-tenants may exist; and each tenant may even be specifically entitled and transactionally tied to a specific set of features all the way day to specific hardware features). A trusted multi-tenant device may further contain a tenant specific cryptographic key such that the combination of key and slice may be considered a “root of trust” (RoT) or tenant specific RoT. A RoT may further be computed dynamically composed using a DICE (Device Identity Composition Engine) architecture such that a single DICE hardware building block may be used to construct layered trusted computing base contexts for layering of device capabilities (such as a Field Programmable Gate Array (FPGA)). The RoT may further be used for a trusted computing context to enable a “fan-out” that is useful for supporting multi-tenancy. Within a multi-tenant environment, the respective edge nodes 422, 424 may operate as security feature enforcement points for local resources allocated to multiple tenants per node. Additionally, tenant runtime and application execution (e.g., in instances 432, 434) may serve as an enforcement point for a security feature that creates a virtual edge abstraction of resources spanning potentially multiple physical hosting platforms. Finally, the orchestration functions 460 at an orchestration entity may operate as a security feature enforcement point for marshalling resources along tenant boundaries.

Edge computing nodes may partition resources (memory, central processing unit (CPU), graphics processing unit (GPU), interrupt controller, input/output (I/O) controller, memory controller, bus controller, etc.) where respective partitionings may contain a RoT capability and where fan-out and layering according to a DICE model may further be applied to Edge Nodes. Cloud computing nodes consisting of containers, FaaS engines, Servlets, servers, or other computation abstraction may be partitioned according to a DICE layering and fan-out structure to support a RoT context for each. Accordingly, the respective RoTs spanning endpoints, nodes, or devices 410, 422, and 440 may coordinate the establishment of a distributed trusted computing base (DTCB) such that a tenant-specific virtual trusted secure channel linking all elements end to end can be established.

Further, it will be understood that a container may have data or workload specific keys protecting its content from a previous edge node. As part of migration of a container, a pod controller at a source edge node may obtain a migration key from a target edge node pod controller where the migration key is used to wrap the container-specific keys. When the container/pod is migrated to the target edge node, the unwrapping key is exposed to the pod controller that then decrypts the wrapped keys. The keys may now be used to perform operations on container specific data. The migration functions may be gated by properly attested edge nodes and pod managers (as described above).

In further examples, an edge computing system is extended to provide for orchestration of multiple applications through the use of containers (a contained, deployable unit of software that provides code and needed dependencies) in a multi-owner, multi-tenant environment. A multi-tenant orchestrator may be used to perform key management, trust anchor management, and other security functions related to the provisioning and lifecycle of the trusted ‘slice’ concept in FIG. 4. For instance, an edge computing system may be configured to fulfill requests and responses for various client endpoints from multiple virtual edge instances (and, from a cloud or remote data center). The use of these virtual edge instances may support multiple tenants and multiple applications (e.g., augmented reality (AR)/virtual reality (VR), enterprise applications, content delivery, gaming, compute offload) simultaneously. Further, there may be multiple types of applications within the virtual edge instances (e.g., normal applications; latency sensitive applications; latency-critical applications; user plane applications; networking applications; etc.). The virtual edge instances may also be spanned across systems of multiple owners at different geographic locations (or respective computing systems and resources which are co-owned or co-managed by multiple owners).

For instance, each edge node 422, 424 may implement the use of containers, such as with the use of a container “pod” 426, 428 providing a group of one or more containers. In a setting that uses one or more container pods, a pod controller or orchestrator is responsible for local control and orchestration of the containers in the pod. Various edge node resources (e.g., storage, compute, services, depicted with hexagons) provided for the respective edge slices 432, 434 are partitioned according to the needs of each container.

With the use of container pods, a pod controller oversees the partitioning and allocation of containers and resources. The pod controller receives instructions from an orchestrator (e.g., orchestrator 460) that instructs the controller on how best to partition physical resources and for what duration, such as by receiving key performance indicator (KPI) targets based on SLA contracts. The pod controller determines which container requires which resources and for how long in order to complete the workload and satisfy the SLA. The pod controller also manages container lifecycle operations such as: creating the container, provisioning it with resources and applications, coordinating intermediate results between multiple containers working on a distributed application together, dismantling containers when workload completes, and the like. Additionally, a pod controller may serve a security role that prevents assignment of resources until the right tenant authenticates or prevents provisioning of data or a workload to a container until an attestation result is satisfied.

Also, with the use of container pods, tenant boundaries can still exist but in the context of each pod of containers. If each tenant specific pod has a tenant specific pod controller, there will be a shared pod controller that consolidates resource allocation requests to avoid typical resource starvation situations. Further controls may be provided to ensure attestation and trustworthiness of the pod and pod controller. For instance, the orchestrator 460 may provision an attestation verification policy to local pod controllers that perform attestation verification. If an attestation satisfies a policy for a first tenant pod controller but not a second tenant pod controller, then the second pod could be migrated to a different edge node that does satisfy it. Alternatively, the first pod may be allowed to execute, and a different shared pod controller is installed and invoked prior to the second pod executing.

### Accelerated Device Enabling Applications

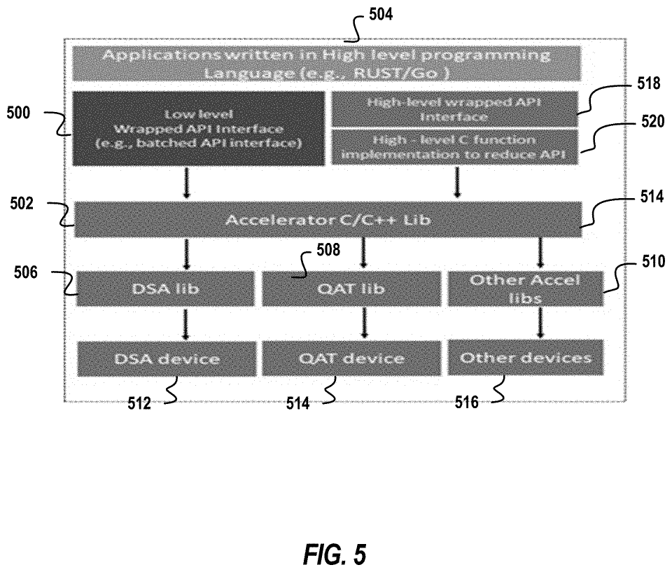

As mentioned briefly earlier herein, example embodiments provide application programming interfaces and wrappers to leverage existing C/C++ libraries to drive hardware offloading devices in a high-level programming language. FIG. 5 illustrates a lightweight wrapper application programming interface (API) for integrating hardware-based accelerators according to some embodiments. Cloud service providers can then access hardware-based accelerators using these APIs.

At least two methods can be provided to leverage existing C/C++ libraries. First, a low-level wrapped API interface 500 can be provided for performance enhancement and improvements. The API interface 500 can be written in Rust or other CN application language. The low-level API 500 can be considered to be a foreign function interface (FFI) that declares a C API. The low-level API 500 can be used by advanced users or developers to provide optimization or more control for special cases. Data structure compatibility can be maintained.

The low-level accelerator library 502 (written in, e.g., C or C++) can then be used with the wrapped API 500. The threading mode or framework provided by high level programming languages 504 can be used with hardware-based accelerators described above, e.g., DSA 506, QAT 508, and other libraries 510 for other accelerators (e.g., DSA device 512, QAT device 514 or other devices 516) can be accessed by high-level applications. The libraries 506, 508, 510 can be written in C or C++ as well. For example, if QAT is to be integrated in Rust, QAT provides a low-level data plane library 508 with a batched API, but without using any thread mode. Then the API is wrapped using wrapper 500 and can access the threading and scheduling model provided in the Rust language (e.g., high level programming languages 504).

In these and other embodiments, a high-level wrapped API interface 518 can be provided for purposes of reduced complexity in usage. The high-level wrapped API interface 518 can be written in Rust or other CN application language and can further abstract the provided function to hide execution details from the user, wherein the high-level abstract functions are provided at block 520 (e.g., in C or C++). The high-level wrapped API interface 518 may be preferred by less-advanced users, or can be optimized for more common usage scenarios that will be seen by a typical less-advanced user. In at least these embodiments, C (or C++) implementations 520 are provided to and shrink the API interfaces given by accelerators' libraries (e.g., DSA 506, QAT 508, and other libraries 510 for other accelerators). Stated another way, in at least these embodiments C language implementations 520 are wrapped with reduced APIs 518. This embodiment can make the applications written in high level programming languages easy (or less complex) to leverage for less-advanced users.

When using the low-level wrapped API 500, for example, an advanced user may provide more parameters for calling into, e.g., QAT library 508 or DSA library 506. Alternatively, if less control is needed, or for less-advanced users in a more user-friendly fashion, only an abstraction is needed and fewer parameters are provided using the high-level wrapped API 518 and abstract functions 520 to call into the same QAT library 508 or DSA library 506.

In some examples, an advanced user using a low-level wrapped API interface can batch multiple operations to access accelerators, whereas a basic user using high-level wrapped API 518 may only be able to perform one operation at a time. For example, an advanced user can perform encryption/decryption operations addition to digest operations in one API call. Batched operation can provide more efficient usage of accelerator API 502 (e.g., accelerator libraries written in C or C++).

Hardware calls (e.g., requests for hardware to perform an operation) can be made synchronously or asynchronously. In synchronous operation callers must wait for result written by hardware and no other operations can be performed until a corresponding hardware accelerator has returned a result. In this sense, synchronous operation is performed in a “blocking” fashion wherein other operations (e.g., threads) are suspended (e.g., blocked) until the synchronous operation is completed. In contrast, in asynchronous operation, other operations can proceed while waiting for a result from an accelerator. The calling application can register an asynchronous callback function so that when the accelerator (or other hardware) function is completed, the calling application can be notified of completion. In the meantime, the calling function can perform other functionalities while waiting for hardware completion and results.

In still further examples, elements and methodologies described above with reference FIG. 5 can be used for scenarios in which a container image is to be loaded (e.g., Nydus framework). A container image is a package that contains software and software dependencies. Nydus can help the software to launch before the image is prepared. Nydus can be understood to be an opensource filesystem solution to form a high-efficiency image distribution system for CN workload, such as container images, software packages, etc. In examples, Nydus can be written in Rust, and example architectures and use cases can make use of QAT and DSA written in C/C++ although embodiments are not limited to being use with QAT, DSA or C/C++.

In examples, Nydus can directly all a Rust-based wrapper library as described above to call into QAT to achieve hardware acceleration. The acceleration library can be directly used as a plugin, which is convenient to call and avoid repetitive wrapper API development.

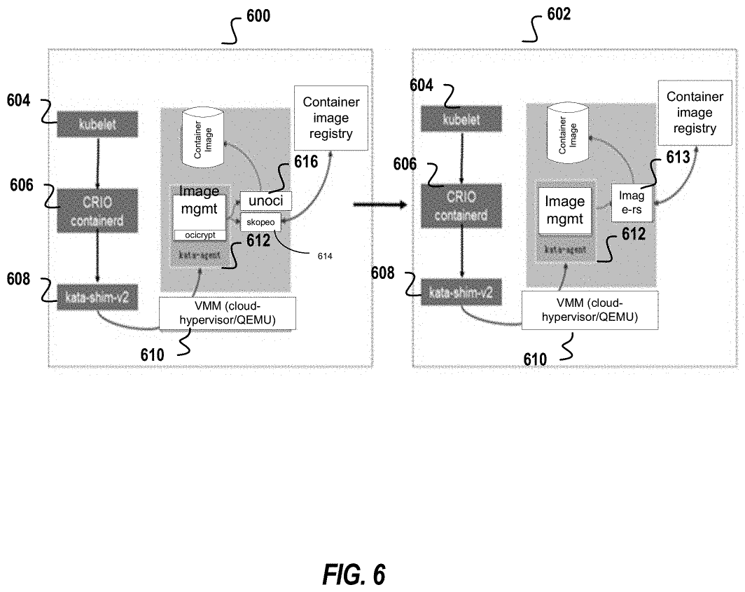

FIG. 6 illustrates a usage example in a container running time environment according to some embodiments. Different versions of the specified components can be used in other examples, and accordingly names provided for these components in the example below may be different in other versions of example embodiments. In FIG. 6, a container's management stack is depicted. Implementation 600 can be one example previous management stack. In currently prevailing trends, software is redesigned or rewritten in Rust in revised implementation 602. In both implementations, kubelet 604 represents a primary node agent that runs on each compute node (wherein compute nodes are defined later herein). The kubelet 604 can register a node with an API service using, e.g., a hostname or a flag to override a host name. The kubelet 604 can work in terms of a pod specification, wherein pods were described earlier herein. The CRIO containerd 606 is used in both of implementations 600, 602 to manage a container lifecycle of a host system (e.g., image transfer and storage, container execution and supervision, low-level storage, network attachments, etc.) The kata-shim 608 is used in both of implementations 600, 602 to run in a host environment to handle standard I/P and signal son behalf of the container process that runs inside a virtual machine 610. Kata-agents 612 run inside virtual machines 610 to manage container processes inside the virtual machine 610, on behalf of the runtime running on the corresponding host.

In the example, image-rs 613 replaces two other components, e.g., skopeo 614 and umoci software 616 to take over an image's downloading, or on-demand decryption/decompression work in image management. The image-rs 613 component can be written in Rust and can call wrapped APIs as (e.g., high-level wrapped API 518) as described above with reference to FIG. 5. And for image decompression/decryption, other accelerated devices (e.g., QAT or other accelerators) can be leveraged. Image-rs can invoke High level wrapped RUST API interface. This interface (e.g., interface 518 (FIG. 5)) can have a reduced API to wrap QATZIP API as described above, then put some offloading logic in implemented C libraries. Finally, there can be a call into the QAT QATZIP library.

For improved performance, a low-level wrapped Rust API can be called that encapsulates the QAT data plane API 508 (FIG. 5) and can issue batched and asynchronous operations to offload the data compression operations.

Moreover, because of limited QAT instances in a machine, a wrapped API can provide auto switching among different accelerated devices and CPU usages. This can eliminate or prevent instances of erroring out or faults that prevent operations.

The image-rs can help a container to run in image unpacking operations. The image-rs 613 can prune container images in parallel because the container image is comprised of different layers that can be pruned in parallel. In examples, The image-rs 613 can launch a daemon thread to prune images. The image-rs 613 can launch a daemon thread that creates an instance of, e.g., QAT, and wait for data sent by layer threads. Each layer thread prepares only one layer of the image. In the slide, the layer-x thread handles the layer-x, which represents any layer of the image. The layer-x thread can prepare other data and send the data through a pipe to the daemon thread. An image can contain several layers, wherein layer-x represents any one of these layers. For convenience, the thread that handles layer-x and sends the data of layer-x to the daemon thread is referred to as the layer-x thread. When the daemon thread is finished, and all layers are unpacked, a daemon thread is finished and other following operations can be performed for the container.

Performance results based on inventive embodiments integrating QAT's compression feature in the image-rs indicate that a 0 to 20% performance improvement can be seen by using QAT in the image-rs with a high-level interface compared with purely CPU solutions on large images (e.g., with size >20 MB). If low-level interface integration is used (e.g., low-level wrapping 500 (FIG. 5) the performance benefit can be increased even further.

Cloud native is the trend and cloud native applications are written by Golang and Rust. Example embodiments described here show efficiently integrate hardware-based accelerators in applications written by high level programming languages (e.g., Rust, Golang). Embodiments provide light-weighted wrapped API with both low level and high-level integration. Wrapped APIs can keep batched or asynchronous API and make the accelerators to be efficiently used by those cloud native applications. Examples can be leveraged with the image-rs, which is an API written by Rust, and it is a significant component of confidential containers' life cycle management software stack. Embodiments can improve computer operations by improving speed and useability from high-level users as well as advanced users.

Cloud providers (CSPs) such as Amazon Web Services (AWS), Google Cloud Platform (GCP), VMWare cloud platform, Alibaba Cloud, Tencent Cloud, Huawei Cloud, and China Telecom CSP etc., can use the API of example embodiments. For example, these or other cloud service providers can utilize the accelerators developed using the low-level API interfaces described above in different software components (e.g., service meshes applications, database applications) in the stack.

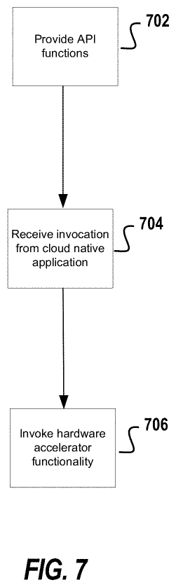

FIG. 7 illustrates a method 700 to enable hardware-based accelerators in cloud native applications written in high level programming languages according to some embodiments. The method 700 can begin with operation 702 with providing an application programming interface (API), the API including functions for invoking accelerator library functions.

The method 700 can continue with operation 704, in which a function of the API is invoked by a high-level cloud native application. The method can include operation 706, in which hardware accelerator functionality is invoked, e.g., hardware accelerator libraries in lower-level languages are invoked to execute

### Other Apparatuses

In further examples, any of the compute nodes or devices discussed with reference to the present edge computing systems and environment may be fulfilled based on the components depicted in FIGS. 8A and 8B. Respective edge compute nodes may be embodied as a type of device, appliance, computer, or other “thing” capable of communicating with other edge, networking, or endpoint components. For example, an edge compute device may be embodied as a personal computer, server, smartphone, a mobile compute device, a smart appliance, an in-vehicle compute system (e.g., a navigation system), a self-contained device having an outer case, shell, etc., or other device or system capable of performing the described functions.

In the simplified example depicted in FIG. 8A, an edge compute node 1000 includes a compute engine (also referred to herein as “compute circuitry”) 1002, an input/output (I/O) subsystem 1008, data storage 1010, a communication circuitry subsystem 1012, and, optionally, one or more peripheral devices 1014. In other examples, respective compute devices may include other or additional components, such as those typically found in a computer (e.g., a display, peripheral devices, etc.). Additionally, in some examples, one or more of the illustrative components may be incorporated in, or otherwise form a portion of, another component.

The compute node 1000 may be embodied as any type of engine, device, or collection of devices capable of performing various compute functions. In some examples, the compute node 1000 may be embodied as a single device such as an integrated circuit, an embedded system, a field-programmable gate array (FPGA), a system-on-a-chip (SOC), or other integrated system or device. In the illustrative example, the compute node 1000 includes or is embodied as a processor 1004 and a memory 1006. The processor 1004 may be embodied as any type of processor capable of performing the functions described herein (e.g., executing an application). For example, the processor 1004 may be embodied as a multi-core processor(s), a microcontroller, or other processor or processing/controlling circuit. In some examples, the processor 1004 may be embodied as, include, or be coupled to an FPGA, an application specific integrated circuit (ASIC), reconfigurable hardware or hardware circuitry, or other specialized hardware to facilitate performance of the functions described herein.

The memory 1006 may be embodied as any type of volatile (e.g., dynamic random access memory (DRAM), etc.) or non-volatile memory or data storage capable of performing the functions described herein. Volatile memory may be a storage medium that requires power to maintain the state of data stored by the medium. Non-limiting examples of volatile memory may include various types of random access memory (RAM), such as DRAM or static random access memory (SRAM). One particular type of DRAM that may be used in a memory module is synchronous dynamic random access memory (SDRAM).

In an example, the memory device is a block addressable memory device, such as those based on NAND or NOR technologies. A memory device may also include a three dimensional crosspoint memory device (e.g., Intel® 3D XPoint™ memory), or other byte addressable write-in-place nonvolatile memory devices. The memory device may refer to the die itself and/or to a packaged memory product. In some examples, 3D crosspoint memory (e.g., Intel® 3D XPoint™ memory) may comprise a transistor-less stackable cross point architecture in which memory cells sit at the intersection of word lines and bit lines and are individually addressable and in which bit storage is based on a change in bulk resistance. In some examples, all or a portion of the memory 1006 may be integrated into the processor 1004. The memory 1006 may store various software and data used during operation such as one or more applications, data operated on by the application(s), libraries, and drivers.

The compute circuitry 1002 is communicatively coupled to other components of the compute node 1000 via the I/O subsystem 1008, which may be embodied as circuitry and/or components to facilitate input/output operations with the compute circuitry 1002 (e.g., with the processor 1004 and/or the main memory 1006) and other components of the compute circuitry 1002. For example, the I/O subsystem 1008 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some examples, the I/O subsystem 1008 may form a portion of a system-on-a-chip (SoC) and be incorporated, along with one or more of the processor 1004, the memory 1006, and other components of the compute circuitry 1002, into the compute circuitry 1002.

The one or more illustrative data storage devices 1010 may be embodied as any type of devices configured for short-term or long-term storage of data such as, for example, memory devices and circuits, memory cards, hard disk drives, solid-state drives, or other data storage devices. Individual data storage devices 1010 may include a system partition that stores data and firmware code for the data storage device 1010. Individual data storage devices 1010 may also include one or more operating system partitions that store data files and executables for operating systems depending on, for example, the type of compute node 1000.

The communication circuitry 1012 may be embodied as any communication circuit, device, or collection thereof, capable of enabling communications over a network between the compute circuitry 1002 and another compute device (e.g., an edge gateway of an implementing edge computing system). The communication circuitry 1012 may be configured to use any one or more communication technology (e.g., wired or wireless communications) and associated protocols (e.g., a cellular networking protocol such a 3GPP 4G or 5G standard, a wireless local area network protocol such as IEEE 802.11/Wi-Fi®, a wireless wide area network protocol, Ethernet, Bluetooth®, Bluetooth Low Energy, a IoT protocol such as IEEE 802.15.4 or ZigBee®, low-power wide-area network (LPWAN) or low-power wide-area (LPWA) protocols, etc.) to effect such communication.

The illustrative communication circuitry 1012 includes a network interface controller (NIC) 1020, which may also be referred to as a host fabric interface (HFI). The NIC 1020 may be embodied as one or more add-in-boards, daughter cards, network interface cards, controller chips, chipsets, or other devices that may be used by the compute node 1000 to connect with another compute device (e.g., an edge gateway node). In some examples, the NIC 1020 may be embodied as part of a system-on-a-chip (SoC) that includes one or more processors, or included on a multichip package that also contains one or more processors. In some examples, the NIC 1020 may include a local processor (not shown) and/or a local memory (not shown) that are both local to the NIC 1020. In such examples, the local processor of the NIC 1020 may be capable of performing one or more of the functions of the compute circuitry 1002 described herein. Additionally, or alternatively, in such examples, the local memory of the NIC 1020 may be integrated into one or more components of the client compute node at the board level, socket level, chip level, and/or other levels.

Additionally, in some examples, a respective compute node 1000 may include one or more peripheral devices 1014. Such peripheral devices 1014 may include any type of peripheral device found in a compute device or server such as audio input devices, a display, other input/output devices, interface devices, and/or other peripheral devices, depending on the particular type of the compute node 1000. In further examples, the compute node 1000 may be embodied by a respective edge compute node (whether a client, gateway, or aggregation node) in an edge computing system or like forms of appliances, computers, subsystems, circuitry, or other components.

In a more detailed example, FIG. 8B illustrates a block diagram of an example of components that may be present in an edge computing node 1050 for implementing the techniques (e.g., operations, processes, methods, and methodologies) described herein. This edge computing node 1050 provides a closer view of the respective components of node 1000 when implemented as or as part of a computing device (e.g., as a mobile device, a base station, server, gateway, etc.). The edge computing node 1050 may include any combinations of the hardware or logical components referenced herein, and it may include or couple with any device usable with an edge communication network or a combination of such networks. The components may be implemented as integrated circuits (ICs), portions thereof, discrete electronic devices, or other modules, instruction sets, programmable logic or algorithms, hardware, hardware accelerators, software, firmware, or a combination thereof adapted in the edge computing node 1050, or as components otherwise incorporated within a chassis of a larger system.

The edge computing device 1050 may include processing circuitry in the form of a processor 1052, which may be a microprocessor, a multi-core processor, a multithreaded processor, an ultra-low voltage processor, an embedded processor, or other known processing elements. The processor 1052 may be a part of a system on a chip (SoC) in which the processor 1052 and other components are formed into a single integrated circuit, or a single package, such as the Edison™ or Galileo™ SoC boards from Intel Corporation, Santa Clara, Calif. As an example, the processor 1052 may include an Intel® Architecture Core™ based CPU processor, such as a Quark™, an Atom™, an i3, an i5, an i7, an i9, or an MCU-class processor, or another such processor available from Intel®. However, any number other processors may be used, such as available from Advanced Micro Devices, Inc. (AMD®) of Sunnyvale, Calif., a MIPS®-based design from MIPS Technologies, Inc. of Sunnyvale, Calif., an ARM®-based design licensed from ARM Holdings, Ltd., or a customer thereof, or their licensees or adopters. The processors may include units such as an A5-A13 processor from Apple® Inc., a Snapdragon™ processor from Qualcomm® Technologies, Inc., or an OMAP™ processor from Texas Instruments, Inc. The processor 1052 and accompanying circuitry may be provided in a single socket form factor, multiple socket form factor, or a variety of other formats, including in limited hardware configurations or configurations that include fewer than all elements shown in FIG. 8B.

The processor 1052 may communicate with a system memory 1054 over an interconnect 1056 (e.g., a bus). Any number of memory devices may be used to provide for a given amount of system memory. As examples, the memory 1054 may be random access memory (RAM) in accordance with a Joint Electron Devices Engineering Council (JEDEC) design such as the DDR or mobile DDR standards (e.g., LPDDR, LPDDR2, LPDDR3, or LPDDR4). In particular examples, a memory component may comply with a DRAM standard promulgated by JEDEC, such as JESD79F for DDR SDRAM, JESD79-2F for DDR2 SDRAM, JESD79-3F for DDR3 SDRAM, JESD79-4A for DDR4 SDRAM, JESD209 for Low Power DDR (LPDDR), JESD209-2 for LPDDR2, JESD209-3 for LPDDR3, and JESD209-4 for LPDDR4. Such standards (and similar standards) may be referred to as DDR-based standards and communication interfaces of the storage devices that implement such standards may be referred to as DDR-based interfaces. In various implementations, the individual memory devices may be of any number of different package types such as single die package (SDP), dual die package (DDP) or quad die package (Q17P). These devices, in some examples, may be directly soldered onto a motherboard to provide a lower profile solution, while in other examples the devices are configured as one or more memory modules that in turn couple to the motherboard by a given connector. Any number of other memory implementations may be used, such as other types of memory modules, e.g., dual inline memory modules (DIMMs) of different varieties including but not limited to microDIMMs or MiniDIMMs.

To provide for persistent storage of information such as data, applications, operating systems and so forth, a storage 1058 may also couple to the processor 1052 via the interconnect 1056. In an example, the storage 1058 may be implemented via a solid-state disk drive (SSDD). Other devices that may be used for the storage 1058 include flash memory cards, such as Secure Digital (SD) cards, microSD cards, eXtreme Digital (XD) picture cards, and the like, and Universal Serial Bus (USB) flash drives. In an example, the memory device may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory.

In low power implementations, the storage 1058 may be on-die memory or registers associated with the processor 1052. However, in some examples, the storage 1058 may be implemented using a micro hard disk drive (HDD). Further, any number of new technologies may be used for the storage 1058 in addition to, or instead of, the technologies described, such resistance change memories, phase change memories, holographic memories, or chemical memories, among others.

The components may communicate over the interconnect 1056. The interconnect 1056 may include any number of technologies, including industry standard architecture (ISA), extended ISA (EISA), peripheral component interconnect (PCI), peripheral component interconnect extended (PCIx), PCI express (PCIe), or any number of other technologies. The interconnect 1056 may be a proprietary bus, for example, used in an SoC based system. Other bus systems may be included, such as an Inter-Integrated Circuit (I2C) interface, a Serial Peripheral Interface (SPI) interface, point to point interfaces, and a power bus, among others.

The interconnect 1056 may couple the processor 1052 to a transceiver 1066, for communications with the connected edge devices 1062. The transceiver 1066 may use any number of frequencies and protocols, such as 2.4 Gigahertz (GHz) transmissions under the IEEE 802.15.4 standard, using the Bluetooth® low energy (BLE) standard, as defined by the Bluetooth® Special Interest Group, or the ZigBee® standard, among others. Any number of radios, configured for a particular wireless communication protocol, may be used for the connections to the connected edge devices 1062. For example, a wireless local area network (WLAN) unit may be used to implement Wi-Fi® communications in accordance with the Institute of Electrical and Electronics Engineers (IEEE) 802.11 standard. In addition, wireless wide area communications, e.g., according to a cellular or other wireless wide area protocol, may occur via a wireless wide area network (WWAN) unit.

The wireless network transceiver 1066 (or multiple transceivers) may communicate using multiple standards or radios for communications at a different range. For example, the edge computing node 1050 may communicate with close devices, e.g., within about 10 meters, using a local transceiver based on Bluetooth Low Energy (BLE), or another low power radio, to save power. More distant connected edge devices 1062, e.g., within about 50 meters, may be reached over ZigBee® or other intermediate power radios. Both communications techniques may take place over a single radio at different power levels or may take place over separate transceivers, for example, a local transceiver using BLE and a separate mesh transceiver using ZigBee®.

A wireless network transceiver 1066 (e.g., a radio transceiver) may be included to communicate with devices or services in the edge cloud 1095 via local or wide area network protocols. The wireless network transceiver 1066 may be a low-power wide-area (LPWA) transceiver that follows the IEEE 802.15.4, or IEEE 802.15.4g standards, among others. The edge computing node 1050 may communicate over a wide area using LoRaWAN™ (Long Range Wide Area Network) developed by Semtech and the LoRa Alliance. The techniques described herein are not limited to these technologies but may be used with any number of other cloud transceivers that implement long range, low bandwidth communications, such as Sigfox, and other technologies. Further, other communications techniques, such as time-slotted channel hopping, described in the IEEE 802.15.4e specification may be used.

Any number of other radio communications and protocols may be used in addition to the systems mentioned for the wireless network transceiver 1066, as described herein. For example, the transceiver 1066 may include a cellular transceiver that uses spread spectrum (SPA/SAS) communications for implementing high-speed communications. Further, any number of other protocols may be used, such as Wi-Fi® networks for medium speed communications and provision of network communications. The transceiver 1066 may include radios that are compatible with any number of 3GPP (Third Generation Partnership Project) specifications, such as Long Term Evolution (LTE) and 5th Generation (5G) communication systems, discussed in further detail at the end of the present disclosure. A network interface controller (NIC) 1068 may be included to provide a wired communication to nodes of the edge cloud 1095 or to other devices, such as the connected edge devices 1062 (e.g., operating in a mesh). The wired communication may provide an Ethernet connection or may be based on other types of networks, such as Controller Area Network (CAN), Local Interconnect Network (LIN), DeviceNet, ControlNet, Data Highway+, PROFIBUS, or PROFINET, among many others. An additional NIC 1068 may be included to enable connecting to a second network, for example, a first NIC 1068 providing communications to the cloud over Ethernet, and a second NIC 1068 providing communications to other devices over another type of network.

Given the variety of types of applicable communications from the device to another component or network, applicable communications circuitry used by the device may include or be embodied by any one or more of components 1064, 1066, 1068, or 1070. Accordingly, in various examples, applicable means for communicating (e.g., receiving, transmitting, etc.) may be embodied by such communications circuitry.

The edge computing node 1050 may include or be coupled to acceleration circuitry 1064, which may be embodied by one or more artificial intelligence (AI) accelerators, a neural compute stick, neuromorphic hardware, an FPGA, an arrangement of GPUs, an arrangement of data processing units (DPUs) or Infrastructure Processing Units (IPUs), one or more SoCs, one or more CPUs, one or more digital signal processors, dedicated ASICs, or other forms of specialized processors or circuitry designed to accomplish one or more specialized tasks. These tasks may include AI processing (including machine learning, training, inferencing, and classification operations), visual data processing, network data processing, object detection, rule analysis, or the like.

The interconnect 1056 may couple the processor 1052 to a sensor hub or external interface 1070 that is used to connect additional devices or subsystems. The devices may include sensors 1072, such as accelerometers, level sensors, flow sensors, optical light sensors, camera sensors, temperature sensors, global navigation system (e.g., GPS) sensors, pressure sensors, barometric pressure sensors, and the like. The hub or interface 1070 further may be used to connect the edge computing node 1050 to actuators 1074, such as power switches, valve actuators, an audible sound generator, a visual warning device, and the like.

In some optional examples, various input/output (I/O) devices may be present within or connected to, the edge computing node 1050. For example, a display or other output device 1084 may be included to show information, such as sensor readings or actuator position. An input device 1086, such as a touch screen or keypad may be included to accept input. An output device 1084 may include any number of forms of audio or visual display, including simple visual outputs such as binary status indicators (e.g., light-emitting diodes (LEDs)) and multi-character visual outputs, or more complex outputs such as display screens (e.g., liquid crystal display (LCD) screens), with the output of characters, graphics, multimedia objects, and the like being generated or produced from the operation of the edge computing node 1050. A display or console hardware, in the context of the present system, may be used to provide output and receive input of an edge computing system; to manage components or services of an edge computing system; identify a state of an edge computing component or service; or to conduct any other number of management or administration functions or service use cases.

A battery 1076 may power the edge computing node 1050, although, in examples in which the edge computing node 1050 is mounted in a fixed location, it may have a power supply coupled to an electrical grid, or the battery may be used as a backup or for temporary capabilities. The battery 1076 may be a lithium ion battery, or a metal-air battery, such as a zinc-air battery, an aluminum-air battery, a lithium-air battery, and the like.

A battery monitor/charger 1078 may be included in the edge computing node 1050 to track the state of charge (SoCh) of the battery 1076, if included. The battery monitor/charger 1078 may be used to monitor other parameters of the battery 1076 to provide failure predictions, such as the state of health (SoH) and the state of function (SoF) of the battery 1076. The battery monitor/charger 1078 may include a battery monitoring integrated circuit, such as an LTC4020 or an LTC2990 from Linear Technologies, an ADT7488A from ON Semiconductor of Phoenix Ariz., or an IC from the UCD90xxx family from Texas Instruments of Dallas, Tex. The battery monitor/charger 1078 may communicate the information on the battery 1076 to the processor 1052 over the interconnect 1056. The battery monitor/charger 1078 may also include an analog-to-digital (ADC) converter that enables the processor 1052 to directly monitor the voltage of the battery 1076 or the current flow from the battery 1076. The battery parameters may be used to determine actions that the edge computing node 1050 may perform, such as transmission frequency, mesh network operation, sensing frequency, and the like.

A power block 1080, or other power supply coupled to a grid, may be coupled with the battery monitor/charger 1078 to charge the battery 1076. In some examples, the power block 1080 may be replaced with a wireless power receiver to obtain the power wirelessly, for example, through a loop antenna in the edge computing node 1050. A wireless battery charging circuit, such as an LTC4020 chip from Linear Technologies of Milpitas, Calif., among others, may be included in the battery monitor/charger 1078. The specific charging circuits may be selected based on the size of the battery 1076, and thus, the current required. The charging may be performed using the Airfuel standard promulgated by the Airfuel Alliance, the Qi wireless charging standard promulgated by the Wireless Power Consortium, or the Rezence charging standard, promulgated by the Alliance for Wireless Power, among others.

The storage 1058 may include instructions 1082 in the form of software, firmware, or hardware commands to implement the techniques described herein. Although such instructions 1082 are shown as code blocks included in the memory 1054 and the storage 1058, it may be understood that any of the code blocks may be replaced with hardwired circuits, for example, built into an application specific integrated circuit (ASIC).

In an example, the instructions 1082 provided via the memory 1054, the storage 1058, or the processor 1052 may be embodied as a non-transitory, machine-readable medium 1060 including code to direct the processor 1052 to perform electronic operations in the edge computing node 1050. The processor 1052 may access the non-transitory, machine-readable medium 1060 over the interconnect 1056. For instance, the non-transitory, machine-readable medium 1060 may be embodied by devices described for the storage 1058 or may include specific storage units such as optical disks, flash drives, or any number of other hardware devices. The non-transitory, machine-readable medium 1060 may include instructions to direct the processor 1052 to perform a specific sequence or flow of actions, for example, as described with respect to the flowchart(s) and block diagram(s) of operations and functionality depicted above. As used herein, the terms “machine-readable medium” and “computer-readable medium” are interchangeable.

Also in a specific example, the instructions 1082 on the processor 1052 (separately, or in combination with the instructions 1082 of the machine readable medium 1060) may configure execution or operation of a trusted execution environment (TEE) 1090. In an example, the TEE 1090 operates as a protected area accessible to the processor 1052 for secure execution of instructions and secure access to data. Various implementations of the TEE 1090, and an accompanying secure area in the processor 1052 or the memory 1054 may be provided, for instance, through use of Intel® Software Guard Extensions (SGX) or ARM® TrustZone® hardware security extensions, Intel® Management Engine (ME), or Intel® Converged Security Manageability Engine (CSME). Other aspects of security hardening, hardware roots-of-trust, and trusted or protected operations may be implemented in the device 1050 through the TEE 1090 and the processor 1052.

In further examples, a machine-readable medium also includes any tangible medium that is capable of storing, encoding or carrying instructions for execution by a machine and that cause the machine to perform any one or more of the methodologies of the present disclosure or that is capable of storing, encoding or carrying data structures utilized by or associated with such instructions. A “machine-readable medium” thus may include but is not limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks. The instructions embodied by a machine-readable medium may further be transmitted or received over a communications network using a transmission medium via a network interface device utilizing any one of a number of transfer protocols (e.g., Hypertext Transfer Protocol (HTTP)).

A machine-readable medium may be provided by a storage device or other apparatus which is capable of hosting data in a non-transitory format. In an example, information stored or otherwise provided on a machine-readable medium may be representative of instructions, such as instructions themselves or a format from which the instructions may be derived. This format from which the instructions may be derived may include source code, encoded instructions (e.g., in compressed or encrypted form), packaged instructions (e.g., split into multiple packages), or the like. The information representative of the instructions in the machine-readable medium may be processed by processing circuitry into the instructions to implement any of the operations discussed herein. For example, deriving the instructions from the information (e.g., processing by the processing circuitry) may include: compiling (e.g., from source code, object code, etc.), interpreting, loading, organizing (e.g., dynamically or statically linking), encoding, decoding, encrypting, unencrypting, packaging, unpackaging, or otherwise manipulating the information into the instructions.

In an example, the derivation of the instructions may include assembly, compilation, or interpretation of the information (e.g., by the processing circuitry) to create the instructions from some intermediate or preprocessed format provided by the machine-readable medium. The information, when provided in multiple parts, may be combined, unpacked, and modified to create the instructions. For example, the information may be in multiple compressed source code packages (or object code, or binary executable code, etc.) on one or several remote servers. The source code packages may be encrypted when in transit over a network and decrypted, uncompressed, assembled (e.g., linked) if necessary, and compiled or interpreted (e.g., into a library, stand-alone executable, etc.) at a local machine, and executed by the local machine.

### Notes and Examples

Example 1 is a machine-readable medium including instructions that, when executed on a processor, cause the processor to perform operations comprising: invoking, from a software application, a hardware accelerator library using an application programming interface (API) function; registering a callback function within the software application to be invoked upon completion of a hardware accelerator library operation; and accessing hardware functionality of a computing system using the hardware accelerator library.

In Example 2, the subject matter of Example 1 can optionally include wherein the software application is a cloud native (CN) application and wherein the hardware accelerator library operation is asynchronous.

In Example 3, the subject matter of Example 2 can optionally include wherein the CN application source code is written in one of a high-level programming language including one of a Rust computer language or a GO computer language.

In Example 4, the subject matter of any of Examples 1-3 can optionally include wherein the API function invokes a function of a low-level accelerator library and the low-level accelerator library invokes a corresponding hardware accelerator.

In Example 5, the subject matter of Example 4 can optionally include wherein the low-level accelerator library is written in one of C, C++, or assembly computing language.

In Example 6, the subject matter of Example 5 can optionally include wherein the operations further comprise providing a data plane library corresponding to at least one hardware accelerator.

In Example 7, the subject matter of any of Examples 1-6 can optionally include wherein the API comprises a high-level API interface and high-level abstraction functions separate from the high-level API, the high-level abstraction functions invoked by the high-level API to invoke hardware accelerator functions.

In Example 8, the subject matter of any of Examples 1-7 can optionally include batching a plurality of invocations.

Example 9 is a method comprising: invoking, from a software application, a hardware accelerator library using an application programming interface (API) function; registering a callback function within the software application to be invoked upon completion of a hardware accelerator library operation; and accessing hardware functionality of a computing system using the hardware accelerator library.

In Example 10, the subject matter of Example 9 can optionally include wherein the software application is a cloud native (CN) application and wherein the hardware accelerator library operation is asynchronous.

In Example 11, the subject matter of any of Examples 9-10 can optionally include wherein the CN application source code is written in one of a high-level programming language including one of a Rust computer language or a GO computer language.

In Example 12, the subject matter of Example 11 can optionally include wherein the API function invokes a function of a low-level accelerator library and the low-level accelerator library invokes a corresponding hardware accelerator.

In Example 13, the subject matter of Example 12 can optionally include wherein the low-level accelerator library is written in one of C, C++, or assembly computing language.

In Example 14, the subject matter of any of Examples 9-13 can optionally include providing a data plane library corresponding to at least one hardware accelerator.

In Example 15, the subject matter of any of Examples 9-14 can optionally include wherein the API comprises a high-level API interface and high-level abstraction functions separate from the high-level API, the high-level abstraction functions invoked by the high-level API to invoke hardware accelerator functions.

In Example 16, the subject matter of any of Examples 9-15 can optionally include batching a plurality of invocations.

Example 17 is a machine-readable medium including instructions that, when executed on a processor, cause the processor to perform operations comprising: receiving a request from an application programming interface (API) function to access a hardware accelerator library; accessing hardware functionality of a computing system using the hardware accelerator library; and providing a result of the hardware functionality to a callback function associated with the API function.

In Example 18, the subject matter of Example 17 can optionally include wherein the hardware accelerator library operation is asynchronous with the API function.

In Example 19, the subject matter of any of Examples 17-18 can optionally include wherein the hardware functionality includes a cryptographic operation.

In Example 20, the subject matter of any of Examples 17-19 can optionally include wherein the low-level accelerator library is written in one of C, C++, or assembly computing language.

Example 21 is a system including means for performing any of Examples 1-20.

Example 22 is a method for performing any of Examples 1-20.

What is claimed is:

1. A machine-readable medium including instructions that, when executed on a processor, cause the processor to perform operations comprising:
invoking, from a software application, a hardware accelerator library using an application programming interface (API) function;
registering a callback function within the software application to be invoked upon completion of a hardware accelerator library operation; and
accessing hardware functionality of a computing system using the hardware accelerator library.

2. The machine-readable medium of claim 1, wherein the software application is a cloud native (CN) application and wherein the hardware accelerator library operation is asynchronous.

3. The machine-readable medium of claim 2, wherein the CN application source code is written in one of a high-level programming language including one of a Rust computer language or a GO computer language.

4. The machine-readable medium of claim 1, wherein the API function invokes a function of a low-level accelerator library and the low-level accelerator library invokes a corresponding hardware accelerator.

5. The machine-readable medium of claim 4, wherein the low-level accelerator library is written in one of C, C++, or assembly computing language.

6. The machine-readable medium of claim 5, wherein the operations further comprise providing a data plane library corresponding to at least one hardware accelerator.

7. The machine-readable medium of claim 1, wherein the API comprises a high-level API interface and high-level abstraction functions separate from the high-level API, the high-level abstraction functions invoked by the high-level API to invoke hardware accelerator functions.

8. The machine-readable medium of claim 1, further comprising batching a plurality of invocations.

9. A method comprising:
invoking, from a software application, a hardware accelerator library using an application programming interface (API) function;
registering a callback function within the software application to be invoked upon completion of a hardware accelerator library operation; and
accessing hardware functionality of a computing system using the hardware accelerator library.

10. The method of claim 9, wherein the software application is a cloud native (CN) application and wherein the hardware accelerator library operation is asynchronous.

11. The method of claim 9, wherein the CN application source code is written in one of a high-level programming language including one of a Rust computer language or a GO computer language.

12. The method of claim 11, wherein the API function invokes a function of a low-level accelerator library and the low-level accelerator library invokes a corresponding hardware accelerator.

13. The method of claim 12, wherein the low-level accelerator library is written in one of C, C++, or assembly computing language.

14. The method of claim 9, further comprising providing a data plane library corresponding to at least one hardware accelerator.

15. The method of claim 9, wherein the API comprises a high-level API interface and high-level abstraction functions separate from the high-level API, the high-level abstraction functions invoked by the high-level API to invoke hardware accelerator functions.

16. The method of claim 9, further comprising batching a plurality of invocations.

17. A machine-readable medium including instructions that, when executed on a processor, cause the processor to perform operations comprising:
receiving a request from an application programming interface (API) function to access a hardware accelerator library;
accessing hardware functionality of a computing system using the hardware accelerator library; and
providing a result of the hardware functionality to a callback function associated with the API function.

18. The machine-readable medium of claim 17, wherein the hardware accelerator library operation is asynchronous with the API function.

19. The machine-readable medium of claim 17, wherein the hardware functionality includes a cryptographic operation.

20. The machine-readable medium of claim 17, wherein the low-level accelerator library is written in one of C, C++, or assembly computing language.
